(19) United States
(12) Patent Application Publication
(10) Pub. No.: US 2007/0147467 A1
(43) Pub. Date: Jun. 28, 2007

(54) Apparatus and Method for Measuring a Condensable Component of a Gas Sample

(75) Inventors: Ian Michael Arnold, Cambridgeshire (GB); Raymond Anthony George Hinkins, Cambridgeshire (GB); Andrew Maurice Vincent Stokes, Cambridgeshire (GB)

Correspondence Address: EDELL, SHAPIRO & FINNAN, LLC, 1901 RESEARCH BOULEVARD, SUITE 400, ROCKVILLE, MD, 20850, US

(73) Assignee: MICHELL INSTRUMENTS LIMITED, Cambridge (GB)

(21) Appl. No.: 11/676,824

(22) Filed: Feb. 20, 2007

Related U.S. Application Data
(63) Continuation of application No. PCT/GB05/03244, filed on Aug. 19, 2005.

(30) Foreign Application Priority Data
Aug. 19, 2004 (GB) 0418555.9

(51) Int. Cl. G01N 25/02

(52) U.S. Cl. 374/28

(57) ABSTRACT

An apparatus for measuring a condensable component of a gas sample, such as a hydrocarbon gas sample, includes a slightly roughened measurement surface for exposure to the gas sample. An electronic cooling device cools the measurement surface to cause at least some of the gas sample to condense on the measurement surface. A light source is arranged to transmit light to the measurement surface and the presence of condensate when formed thereon is detected by a change in light intensity detected by a light detector. The apparatus initiates a sequence of cooling cycles for generating an optimal cooling profile such that the rate of cooling of the measurement surface decreases near the dew point temperature of the gas sample for accurate dew point measurement.

### CROSS REFERENCE TO RELATED APPLICATIONS

This application is a continuation of International Application No. PCT/GB2005/003244 filed on Aug. 19, 2005, entitled “Apparatus and Method for Measuring a Condensable Component of a Gas Sample, which claims priority under 35 U.S.C. §119 to Application No. UK 0418555.9 filed on Aug. 19, 2004, the entire contents of which are hereby incorporated by reference.

### FIELD OF THE INVENTION

The present invention relates to an apparatus and method for measuring a condensation property of a condensable component of a gas sample. More particularly, the present invention relates to the determination of the dew point of a gas sample or changes in the dew point properties of a gas stream.

### BACKGROUND

A variety of devices are based upon the principle of detecting the presence of dew on a cooled surface, for example a mirror, by means of light reflection techniques. Analyzers based on these techniques and variations thereof are currently available to be used for the determination of the water dew point temperature of gas streams, particularly humid air streams. However, their performance is not always as reliable and accurate as might be desired. Humid air is essentially a two-component mixture consisting of a single condensable component in, for all practical purposes, an incondensable carrier. The dew point temperature in such a mixture is therefore easily defined.

However, many gas streams, such as those found in the onshore and offshore gas industry, and in gas processing and industrial plants, are often complex mixtures for which the dew point temperature is less readily defined. Such a mixture can be regarded as a series of condensable fractions, and dew point temperature is then defined as that temperature, at fixed pressure (or vice versa), when measurable dew can be detected. Further decrease in temperature will increase the amount of dew formed as more of the heavier fractions first condense. It has been found that quantities of heavier fractions present in small, but still analytically significant, quantities, have a profound influence on the dew point temperature of such a mixture.

In order to obtain an accurate indication of the dew point temperature it is necessary to meet predetermined requirements as to temperature and pressure and it will be necessary to present a gas sample to be investigated under controlled conditions to the detection device, measurement cell or dew point analyzer.

Some analyzers make use of a dew point calculation model using gas composition data taken from, typically, a gas chromatograph or other source of data capable of determining the fractional composition of the gas stream. The resulting calculated dew point temperatures are predictions of the gas stream dew point temperature and may not be valid if the chromatograph is not sensitive enough to quantify all species present in the gas stream. This type of analysis does not necessarily guarantee that the calculated dew point is the temperature at which the first condensable component in the gas stream will begin to drop out and is therefore potentially useful only as a general indication.

Many current devices for use with complex mixtures of gases use techniques based on the visual observation of dew on a cooled plane-mirror surface. These devices are typically manual or semi-automatic in operation. Their sensitivity is poor, however, and the observation and interpretation of visual dew formation is subjective and susceptible to operator bias or misreading. Work using these principles, but with electronic detection of the change in light reflectance, demonstrated that the signal thus obtained is noisy, transient and unreliable. Condensed water is relatively easy to detect as it condenses in a drop-wise manner, but complex mixtures of gases condense with much lower contact angles and quickly form a film on the surface, thus restoring reflection and tending to make the accurate detection of the first condensable component difficult to achieve with good accuracy and repeatability. Such devices generally do not provide a reliable, repeatable and accurate indication of the formation of the first significant condensation of heavier components, which define the dew point temperature.

An improvement over devices utilizing electronic detection of the change in light reflectance is described in EP-A-0205196. In this document, there is described an apparatus for detecting condensable components in a gas stream. The apparatus includes a measurement surface exposed to a gas sample when in use, and a cooling device adapted to cause at least some of the gas sample to condense on the measurement surface. Light is transmitted to the measurement surface, and the presence of condensation on the measurement surface is detected according to a change in the intensity of scattered light detected by a light detector. In contrast to prior devices wherein an increase in light reflectance is detected upon the formation of dew on the measurement surface, the device of EP-A-0205196 relies on the detection of a decrease in the intensity of scattered light returned from the measurement surface to the light detector as dew forms. In this manner, thin films of condensate which may form immediately can be accurately detected, which had not previously been possible.

The accurate detection of dew point of hydrocarbon gas streams poses further problems since a hazardous area is defined where the high pressure flammable hydrocarbon gases may be subject to ignition. Due to their heat output and high voltage electrical power supply, control electronics of the measurement device are disposed from the gas stream to reduce the risk of gas ignition. Prior devices have therefore typically been difficult to install, requiring additional pipework to bleed off gas from the measurement point of the gas pipeline and transport this, often many meters, to the measurement device installation position. A further problem in prior devices is that, in an effort to achieve high sensitivity, they require regular re-calibration and maintenance which, on remote field sites, can lead to site downtime until a suitable engineer can arrive on site.

### SUMMARY

The present invention provides an apparatus and method for accurately measuring a condensation property of a condensable component of a gas sample that gives reliable and reproducible results. The apparatus is easy to install, preferably by a single person, close to, or even directly onto, a gas pipeline. The apparatus of the present invention is suitable for hydrocarbon dew point measurement, satisfying relevant safety regulations. Further, the apparatus is automatically, and optionally remotely, operable from the time of installation.

A first aspect of the present invention is an apparatus for measuring a condensation property of a condensable component of a gas sample, comprising a measurement surface exposed to the gas sample when in use, and a cooling device adapted for cooling the measurement surface to cause at least some of the gas sample to condense thereon for measurement when in use, wherein the cooling device is an electronic cooling device.

The apparatus according to the first aspect of the present invention is advantageous in that it becomes possible to provide a cooling device of small size which outputs a minimum of waste heat.

Optionally, the cooling device is a Peltier effect device which may also act as a heater for heating the measurement surface to promote evaporation of condensate therefrom.

A second aspect of the present invention is an apparatus for measuring a condensation property of a condensable component of a gas sample, comprising a measurement surface exposed to the gas sample when in use, a cooling device adapted for cooling the measurement surface to cause at least some of the gas sample to condense thereon for measurement when in use, a detector for detecting, when in use, the presence of condensate formed on the measurement surface, and a controller connected to the detector and to the cooling device, adapted to control a rate of cooling of the measurement surface according to a signal output by the detector.

The apparatus according to the second aspect of the present invention is advantageous in that it becomes possible to alter the rate of cooling of the measurement surface such that first presence of condensate on the measurement surface may be initially roughly detected during a first cooling cycle and then more accurately detected under substantially identical gas conditions during a second cooling cycle wherein the rate of cooling is decreased near the temperature at which condensate began to form during the first cooling cycle, thereby enabling more accurate measurement of the first presence of condensate.

The rate of cooling may be controlled according to a predetermined profile. The apparatus may further comprise a temperature sensor for detecting the temperature of the measurement surface.

A third aspect of the present invention is an apparatus for measuring a condensation property of a condensable component of a gas sample, comprising a measurement surface exposed to the gas sample when in use, upon which at least some of the gas sample condenses for measurement when in use, and a heating device adapted for heating the measurement surface to promote evaporation of the condensate from the measurement surface when in use, to thereby perform a cleaning operation of the measurement surface.

The apparatus according to the third aspect of the present invention is advantageous in that it becomes possible to heat the measurement surface both between measurement cycles to evaporate any condensate from the measurement surface rapidly such that the sampling time is small, and also during non-operational periods wherein the apparatus executes a self-clean operation to remove both residual condensed fractions and contaminants, such as glycols, from the measurement surface by heating it to a high temperature.

A controller may be connected to the heating device, adapted to control a rate of heating of the measurement surface. The rate of heating may be executed according to a predetermined heating profile to cause all condensate or contaminants formed thereon to evaporate therefrom. The heating device may be a Peltier effect device which also acts as a cooling device for cooling the measurement surface.

A fourth aspect of the present invention is an apparatus for measuring a condensation property of a condensable component of a pressurized gas sample, comprising a measurement cell including a housing and a measurement member which define, in part, a pressurizable gas chamber containing, when in use, the pressurized gas sample, the measurement member having a surface which is exposed to the gas sample when in use, a cooling device adapted for cooling the measurement member to cause at least some of the gas sample to condense on the measurement surface thereof for measurement when in use, the cooling device being in contact with the measurement member; and a rigid mounting plate upon which the cooling device and the measurement cell are mounted, wherein the cooling device is directly mounted on the mounting plate, and the housing of the measurement cell is indirectly mounted on the mounting plate via a resilient member so as to be resiliently displaceable with respect to the mounting plate such that pressure forces generated in the gas chamber, when in use, are substantially isolated from the cooling device, while substantially uniform thermal contact between the measurement member and the cooling device is maintained.

The apparatus according to the fourth aspect of the present invention is advantageous in that it becomes possible to protect the cooling device from high pressure forces generated in the gas chamber during use, particularly where the cooling device is a sensitive electronic cooling device such as a Peltier effect device, while uniform physical, and therefore electrical, contact between the cooling device and the measurement surface is maintained, in a robust apparatus.

The resilient member may be made of Nylon, Acetal, PTFE, or any other suitable material. The resilient member can be fixed to the mounting plate and has a flange which captures the housing of the measurement cell, the flange being elastically deformable to allow displacement of the housing relative to the mounting plate.

A fifth aspect of the present invention is an apparatus for measuring a condensation property of a condensable component of a gas sample, comprising a measurement surface exposed to the gas sample when in use, a detector for detecting, when in use, the presence of condensate formed on the measurement surface from the gas sample, an analyzer connected to the detector for analyzing the presence of condensate formed on the measurement surface according to a signal output by the detector when in use, and a flameproof enclosure, wherein the measurement surface, the detector and the analyzer are all contained within the flameproof enclosure.

The apparatus according to the fifth aspect of the present invention is advantageous in that it may be provided as a single unit of a size suitable to be carried by a single person, which may be easily installed for use in measuring hydrocarbon gas samples near a gas pipeline, even in remote locations.

The flameproof enclosure can include a gas inlet and a gas outlet, a gas flow path between the gas inlet and the gas outlet along which the gas sample travels, when in use, the measurement surface being disposed on the gas flow path. For use in measuring hydrocarbon or other flammable gases, the gas inlet and gas outlet may be provided with flame arrestors made of metal mesh or sinter material in order to suitably disperse and extinguish a flame path.

A sixth aspect of the present invention is an apparatus for measuring a condensation property of a condensable component of a gas sample, comprising an enclosure having a gas inlet and a gas outlet, a gas flow path between the gas inlet and the gas outlet along which the gas sample travels when in use, a measurement surface exposed to the gas sample when in use, disposed on the gas flow path and upon which at least some of the gas sample condenses for measurement, when in use, and a gas flow valve disposed on the gas flow path for selectively allowing or obstructing passage of gas along the gas flow path, wherein the gas flow valve is electrically controlled by a controller and configured to obstruct passage of gas along the gas flow path in a controller power-off condition, and has a manual mechanical override to allow passage of gas along the gas flow path in the power-off condition such that a gas purge operation of the gas flow path may be carried out in the power-off condition.

The apparatus according to the sixth aspect of the present invention is advantageous in that it becomes possible to purge clean the apparatus in a power-off condition, while maintaining a high level of apparatus safety in the event of an electrical fault, particularly where the apparatus is to be used in measuring hydrocarbon or other flammable gases.

The gas flow valve can be a solenoid valve. The manual mechanical override may include a threaded member, for example a screw, rotation of which forces open the closed solenoid valve.

A seventh aspect of the present invention is an apparatus for measuring a condensation property of condensable components of a gas stream, comprising an enclosure having first and second gas inlets and first and second gas outlets, a first gas flow path between the first gas inlet and the first gas outlet along which a first gas sample travels when in use, a second gas flow path between the second gas inlet and the second gas outlet along which a second gas sample travels when in use, a hydrocarbon dew point analyzer having a measurement surface exposed to the first gas flow path upon which at least some of a gas sample condenses for measurement, when in use, and a water dew point analyzer having a measurement surface exposed to the second gas flow path upon which at least some of a gas sample condenses for measurement when in use.

The apparatus according to the seventh aspect of the present invention is advantageous in that it becomes possible to measure both water and hydrocarbon dew point of a gas sample using a single compact device while maintaining a high degree of apparatus safety satisfying all relevant safety regulations.

An eighth aspect of the present invention is an apparatus for measuring a condensation property of a condensable component of a gas sample, comprising a measurement cell including a housing and a measurement member which define, in part, a pressurizable gas chamber containing, when in use, the pressurized gas sample, the measurement member having a surface which is exposed to the gas sample for measurement when in use, and a mounting plate upon which the measurement cell is mounted, wherein a space is created between the measurement member and the mounting plate and a conduit connects the space to the outside of the measurement cell such that if an over-pressure is generated in the gas chamber, the measurement cell is adapted to fail to allow the over-pressurized gas of the gas chamber to exhaust into the space and to the outside of the measurement cell via the conduit.

The apparatus according to the eighth aspect of the present invention is advantageous in that it becomes possible to safely exhaust gas from the gas chamber to the outside of the measurement cell which may be provided in a flameproof enclosure such that it is suitable for use in measurement of hydrocarbon or other flammable gas samples safely.

A ninth aspect of the present invention is an apparatus for measuring a condensation property of a condensable component of a gas sample, including a measurement surface exposed to the gas sample and upon which at least some of a gas sample condenses for measurement, when in use, the measurement surface being disposed inside a flameproof enclosure, wherein the apparatus controls are user-operable via a touch screen from outside the enclosure.

The apparatus according to the ninth aspect of the present invention is advantageous in that it becomes possible to provide the apparatus controls within a hazardous environment where the apparatus is to be used for hydrocarbon or other flammable gas measurement, but which are operable from a safe area adjacent the hazardous area.

A tenth aspect of the present invention is an apparatus for measuring a condensation property of condensable components of a gas stream, having an interface for connection to a remote monitoring and control device via a network.

The apparatus according to the tenth aspect of the present invention is advantageous in that it becomes possible to interface a plurality of such apparatus as a system for simultaneous measurement of a gas stream, or for the apparatus to be located in unmanned locations under remote control. The network may be the internet, or a local area network.

The apparatus of any of the first to tenth aspects of the invention may further comprise any of the features of any other aspect or aspects of the present invention.

The apparatus of any of the first to tenth aspects of the invention, or any combination thereof, optionally further comprises a light source which transmits light to the measurement surface, a light detector positioned in the path of substantially only the scattered light returned from the measurement surface when in the absence of condensate, and in the path of the light directly reflected from the measurement surface when in the presence of condensate, and a processor which determines the presence of condensate on the measurement surface according to a change in the intensity of light detected by the light detector.

In this manner, thin films of condensate which may form immediately on the measurement surface may be accurately detected.

In an exemplary embodiment, the measurement surface is slightly roughened such that incident light is substantially reflected and partially scattered when in the absence of condensate, and the measurement surface is at least partially formed as a shallow depression having an inverse-conical shape. The depression subtends an angle of approximately 6.5 degrees and has a maximum depth of approximately 0.34 mm. The light source and the light detector are respectively disposed on opposite sides of a plane centered on the depression and have equivalent focal lengths. The light source and the light detector have respective optical axes each of which subtend an angle of approximately 12.5 degrees from the plane centered on the depression. The presence of condensate on the measurement surface is determined by the processor according to a predetermined change in the intensity of light detected by the light detector. It will be appreciated by those skilled in the art than one or more features of the above exemplary embodiment may be incorporated into the apparatus of the first to tenth aspects of the present invention.

An eleventh aspect of the present invention is a method for measuring a condensation property of a condensable component of a gas stream comprising the steps of providing a measurement surface, providing a sample of gas, exposing the measurement surface to the gas sample, promoting condensation of at least some of the gas sample on the measurement surface by cooling in a first cooling cycle, determining the presence of condensate on the measurement surface, promoting evaporation of condensation from the measurement surface, and promoting condensation of at least some of the gas sample on the measurement surface by cooling in a second cooling cycle, wherein during the second cooling cycle the rate of cooling is decreased near a temperature at which the presence of condensate was determined in the first cooling cycle such that a condensation temperature of the gas sample is accurately determinable.

The method according to the eleventh aspect of the present invention is advantageous in that it becomes possible to more accurately determine the condensation temperature of the earliest fractions of the gas sample.

The method may further comprises providing a light source and transmitting light towards the measurement surface which has been slightly roughened such that incident light is substantially reflected and partially scattered when in the absence of condensate, positioning a light detector in the path of substantially only the scattered light returned from the measurement surface when in the absence of condensate, and in the path of the light directly reflected from the measurement surface when in the presence of condensate, and determining the presence of condensate on the measurement surface as a function of a reduction in the intensity of scattered light returned from the measurement surface according to a signal output by the light detector.

To promote condensation, the method may comprises cooling the measurement surface. The rate of cooling of the measurement surface may be variably controlled such that the rate of cooling is decreased near the condensation temperature and can prove the accuracy of the measurement. The method may further include initiating a learning sequence to determine an optimum cooling rate profile for the gas sample for measurement. If the gas sample is provided as a gas stream, any change in the pluralities of the gas stream may be detected by a suitable detector and the learning sequence reinitiated to ensure an optimum cooling rate profile for all gas samples as the gas stream. Such a learning sequence may further comprise heating the measurement surface to cause any condensate formed thereon to evaporate. The rate of heating may be variably controlled to cause all condensate to evaporate.

The gas sample may be measured under either continuous flow conditions, or static conditions. In the case of the latter, the gas stream may be interrupted such that a suitable static measurement or gas sample may be conducted.

The method may further comprise using any feature of any one of the first to tenth aspects of the invention.

The above and still further features and advantages of the present invention will become apparent upon consideration of the following definitions, descriptions and descriptive figures of specific embodiments thereof, wherein like reference numerals in the various figures are utilized to designate like components. While these descriptions go into specific details of the invention, it should be understood that variations may and do exist and would be apparent to those skilled in the art based on the descriptions herein.

### BRIEF DESCRIPTION OF THE DRAWINGS

An exemplary embodiment of the present invention will now be described with reference to the accompanying drawings in which:

FIG. 1 is a schematic diagram of a flow scheme of an apparatus in accordance with the embodiment;

FIG. 2 is a cross-section view of a measurement device in accordance with the embodiment; and

FIG. 3 is a cross-section view of the measurement surface showing the pattern of light detection.

### DETAILED DESCRIPTION

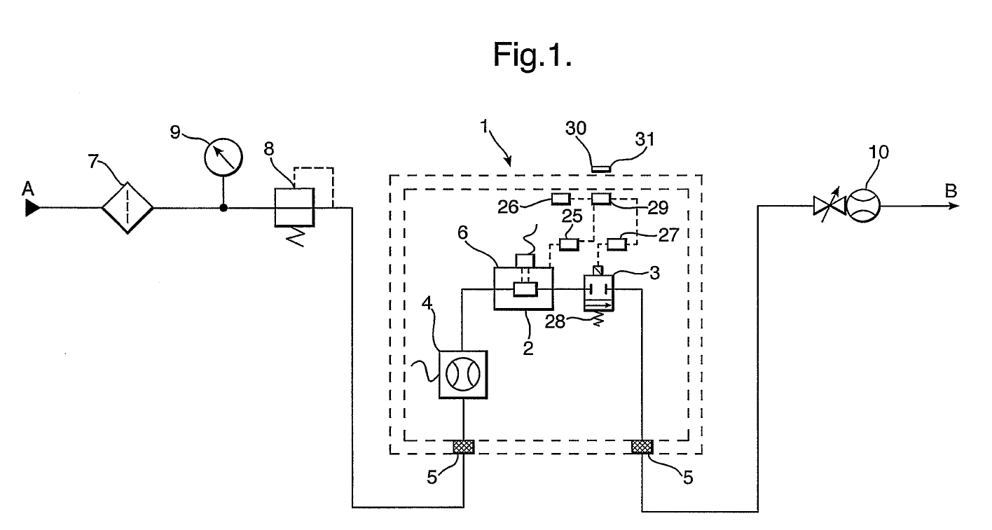

The flow diagram of FIG. 1 shows how a gas sample is taken from a gas stream at point A and flows into an analyzer cabinet 1. The analyzer cabinet 1 may be flameproof or explosion proof for the purposes of hydrocarbon gas measurement. The analyzer cabinet 1 includes a sensor cell 2, a flow interruption device 3, and a gas detector 4. The sensor cell 2 is described in greater detail hereinafter.

The flow interruption device 3 regulates flow of gas through the sensor cell 2. The flow interruption device 3 can be controlled such that measurements may be conducted in the sensor cell 2 under static (substantially no flow) gas flow conditions or under gas flowing conditions. The flow interruption device 3 may also be controlled such that the sensor cell 2 may be purged of gas prior to conducting measurements. A power supply to the flow interruption device 3 may be isolated from the power supply to the sensor cell 2 such that a purge operation may be carried out while the sensor cell 2 is inoperable.

The solenoid valve flow interruption device 3 is adapted to remain in a closed state when its power supply is off as a safety precaution in the event of an electrical fault. However, the flow interruption device 3 is provided with a mechanical override in the form of a screw, or other threaded member 28, shown schematically in FIG. 1 which, when rotated, forces open the solenoid valve of the flow interruption device 3 such that a purge operation of gas through the sensor cell 2 may be performed. This is necessary to make safe the cabinet 1 when used for measurement of flammable gas samples.

The gas detector 4 is used to detect the presence of gas during measurements and can be utilized to detect a system fault when gas is not present. In the case where the analyzer cabinet 1 is flameproof or explosion-proof, the system is provided with flame arresting devices 5 at the gas stream entry and exit ports. The flame arresting devices 5 are made of mesh or sintered material and are adapted to suitably disperse or extinguish a flame path should one develop in the cabinet 1.

The sensor cell 2 is provided with a pressure measurement device 6 such that the sensor cell 2 may measure dew point temperature under accurately defined pressure conditions.

Downstream of point A, the gas stream flows through a filter 7. The filter 7 may be used to give protection to components housed within the analyzer cabinet 1 from potential contaminates present in the gas stream, such as glycols. Glycols are often added to hydrocarbon gas streams but can leave deposits in the sensor cell 2 thus impeding its operation. The gas stream pressure is controlled by a regulator 8 and displayed by pressure display device 9. The gas flow rate is set by regulator 10 downstream of the analyzer cabinet 1 adjacent point B.

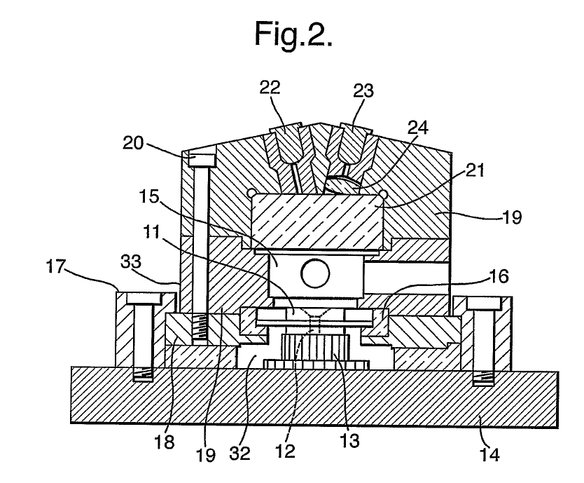

FIG. 2 is a cross-section view through the sensor cell 2. The sensor cell includes a measurement member 11 having a surface having a depression 11b formed thereon. A temperature measurement device 12 continuously measures the temperature of the measurement member 11. The measurement member 11 is heated and cooled by a Peltier effect device 13. The measurement member 11 may be heated and cooled by separate heating and cooling devices or any other suitable integrated heating and cooling device. The sensor cell 2 and the Peltier effect device 13 are mounted on a common mounting plate 14. The sensor cell 2 defines therein a gas chamber 15 which can be pressurized to hold a fixed volume of gas at various pressures, up to 150 barg, during the measurement period.

The Peltier effect device 13 is fairly sensitive and cannot withstand the high pressures which may be experienced in the gas chamber 15 during operation. Accordingly, the Peltier effect device 13 is situated outside the gas chamber 15. However, in order to ensure uniform transfer of heat between the Peltier effect device 13 and the measurement member 11, intimate contact between the Peltier effect device 13 and the measurement member 11 is necessary. This also reduces waste heat thus making the sensor cell 2 suitable for use with hydrocarbon or other flammable gases. The measurement member 11 is also thermally isolated by insulation material 16.

Fixing points 17 are used to retain a housing of the sensor cell 2 with respect to the mounting plate 14 and also prevent damage to the Peltier device 13 when the gas chamber 15 is pressurized. The sensor cell housing comprises a base plate 18 fixed to top plate 19 by fixing element 20 to constrain a viewing window 21. The gas chamber 15 is bounded by the housing, the measurement member 1 1, and the viewing window 21. The safe working pressure of the sensor cell 2 is determined solely by mechanical consideration, and it will be apparent to those skilled in the art that alternative cell constructions may be operable at higher, or lower, pressures than provided by this purely exemplary embodiment of the present invention. The construction of the sensor cell 2 at the present embodiment provides a particularly compact, pressurized gas chamber 15.

The fixing points 17 include a resiliently deformable portion made of Nylon or any other suitable material, having a flange which captures the housing of the sensor cell 2. As the pressure inside the gas chamber 15 increases during use, the housing of the sensor cell 2, while restrained by the fixing points 17, moves relative to the mounting plate 14 in a direction away from the mounting plate such that the pressure loading of the gas chamber 15 is not transferred to the relatively sensitive Peltier effect device 13. This prevents damage to the Peltier effect device.

A light source 22 and a light detector 23 are arranged to have a near coincident focal point on the surface of the measurement member 11. The depression 11b formed on the surface, and the light source 22 and the light detector 23, are arranged such that substantially only scattered light returned from the measurement surface 11b, when in the absence of condensate, reaches the light detector 23, whereas when condensate is formed on the depression 11b of the measurement surface 11, diffraction by the condensate causes incident light transmitted by the light source 22 to be directly reflected towards the light detector 23. The measurement surface 11 is slightly roughened to increase the scattering of incident light returned by the measurement surface when in the absence of condensate.

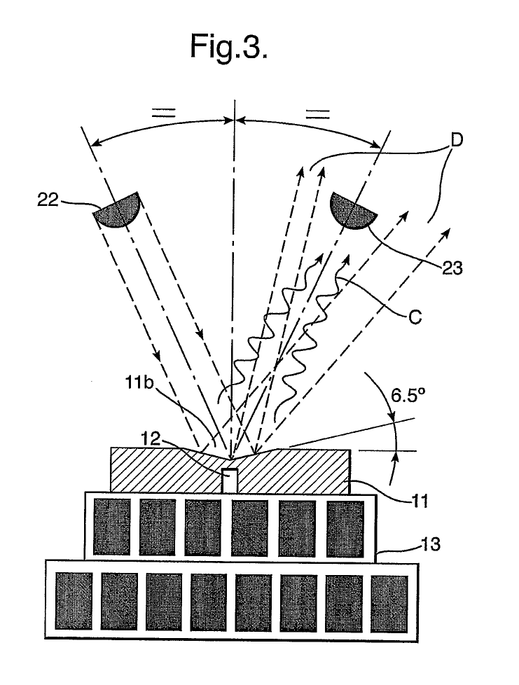

Turning now to FIG. 3, the particular arrangement of the light source 22, the light detector 23, and the measurement member 11 are shown schematically to illustrate the passage of light rays. Light emitted by light source 22 incident on the depression 11b formed on the measurement surface 11 is deflected by the beveled surface of the depression 11b such that, when in the absence of condensate, light directly reflected by the measurement surface 11 by-passes the light detector 23 as light beams D. Due to the slight roughening of the measurement surface 11, scattering of the incident light is promoted and such scattered light is returned from the measurement surface 11 as scattered light beam C towards the light detector 23.

The light source 22 is an LED light source which generates a minimum of waste heat and is compact. This avoids the requirement for expensive optical fiber fed light from a conventional light source, such as a discharge bulb, disposed from the sensor cell as has previously been commonplace.

According to the present embodiment, the light source 22 and light detector 23 are arranged at a half-angle of approximately 12.5° from a plane passing through a center of the depression 11b. This half angle may alternatively be in the range of approximately 10° to 15°.

In FIG. 3, the depression 11b is depicted as an inverse-conical depression which has been found to produce particularly reliable measurements. The inverse-conical depression 11b is shallow, subtends an angle of approximately 6.5° and has a maximum nominal diameter of approximately 6 mm, giving a nominal depth at the center of the depression of approximately 0.34 mm. The relative geometry of the depression 11b, the light source 22 and the light detector 23 provides a particularly compact arrangement of components suitable. Particularly, the angle subtended by the depression may be in the range of approximately 4° to 8° and the depression may be formed as a V-shaped gully rather than an inverse cone.

Returning to FIG. 2, the light source 22 and light detector 23 may be provided with a suitable collimating optical device 24. The collimating optical device 24 improves the homogeneity of the light paths thus improving the reliability and accuracy of the sensor cell 2.

Typical operation of the apparatus of the exemplary embodiment described above will now be described. A sample of gas is taken from a gas stream at point A at a predetermined pressure and flows into the analyzer cabinet 1 through the gas inlet port. Presence of the gas is detected by gas detector 4. The solenoid valve flow interruption device 3 is actuated by its controller 27 from an open to a closed position, and gas flow through the sensor cell 2 is halted. A gas sample then remains in the gas chamber 15 of the sensor cell 2. The Peltier effect device 13 cools the measurement member 11 at a predetermined cooling rate.

As soon as condensable components of the gas sample begin to condense on the depression 11b, due to cooling of the measurement member 11 by the Peltier effect device 13, incident light transmitted by the light source 22 becomes directly reflected, due to diffraction by the condensate on the measurement surface 11, towards the light detector 23. The intensity of the directly reflected light is appreciably higher than the intensity of the scattered light reflected by the dry measurement surface. The change in light intensity detected by the light detector 23 is used to determine the presence of condensate when formed on the measurement surface 11. A signal output by the light detector 23 is fed to a processor 29 external to the sensor cell 2. The processor may be any known microprocessor for evaluating and outputting a predetermined signal on the basis of the signal output by the light detector 23. The processor 29 interacts with an analyzer 26 which outputs information relating to the gas measurement. This may be, for example, the dew point temperature for a predetermined gas pressure and flow rate of the sample. The processor 29 has an associated user interface via a touch screen control panel 30 disposed on a wall of the cabinet 1. The processor also has an associated data interface 31 for remote control.

The Peltier effect device 13 is controlled by a suitable controller 25 for controlling the rate of cooling of the measurement member 11. It is the formation of the first significant condensation of heavier components of the gas sample which defines the dew point temperature of the gas sample. The Peltier effect device 13, when operable to heat the measurement member 11 may be controlled by a suitable controller, which may be the same controller as for controlling the cooling rate, provided for controlling the heating rate of the measurement member 11. The heating rate may be controlled such that all of the condensable fractions of the gas sample are evaporated from the measurement surface 11. In this way, the measurement member 11 may undergo a self-cleaning process.

To improve the accuracy of the detection of the first condensable fractions condensed on the measurement surface, the cooling rate of the measurement surface 11, in one mode of operation, is controlled such that the cooling rate decreases as the temperature of the measurement surface 11 is cooled towards the dew point of the gas sample. In this manner, a cooling rate profile can be constructed according to parameters of the gas sample, such as material constituents of the gas sample, pressure and, if applicable, flow rate.

The apparatus is adapted to execute a learning sequence during which the measurement member 11 is repeatedly cooled and then heated. From the first cycle, the dew point temperature of the gas sample is broadly established. The measurement surface 11 is then reheated to evaporate the condensate from the measurement surface 11. In a subsequent cycle, the cooling rate of the measurement surface is typically rapid from the starting temperature down to a temperature close to the dew point temperature determined by the previous cycle. A secondary, significantly slower cooling rate, is then adopted such that the dew point temperature of the gas sample may be calculated more accurately. This cycle may be repeated many times to improve the accuracy of the dew point temperature calculation. By way of non-limiting example, a cooling rate of between approximately 0.01 and 0.5 degrees Celsius/second can be effected near the condensation temperature.

In the condition that the dew point temperature measurement is carried out on a continuous flowing gas stream, any change in the properties of the gas stream, for example the pressure, automatically reinitiates the learning sequence to determine a new optimum cooling rate profile for the current measurement conditions.

In the embodiment described above, the area immediately surrounding the Peltier effect device 13 is a chamber 32 having a conduit 33 directly connected to the external environment surrounding the sensor cell 2 to provide a pressure relieving path in the event of a rapid expansion of accumulated gas within the sensor cell 2. Such a construction is particularly suitable for use in measurement of hydrocarbon gas.

Various modifications of the present invention will be apparent to those skilled in the art and the embodiment described above is not intended to be limiting on the scope of the present invention which is defined solely by the appended claims.

What is claimed is:

1. An apparatus for measuring a condensation property of a condensable component of a gas sample, comprising:
a measurement surface configured to be exposed to the gas sample; and
a cooling device configured to cool the measurement surface to cause at least some of the gas sample to condense thereon for measurement,

2. The apparatus according to claim 1, wherein the cooling device is an electronic cooling device.

3. The apparatus according to claim 1, wherein the cooling device is a Peltier effect device.

4. The apparatus according to claim 1, further comprising:
a light source which transmits light to the measurement surface;
a light detector positioned in the path of substantially only scattered light returned from the measurement surface in the absence of condensate, and in the path of the light directly reflected from the measurement surface in the presence of condensate; and
a processor which determines the presence of condensate on the measurement surface according to a change in the intensity of light detected by the light detector.

5. The apparatus according to claim 4, wherein the measurement surface is slightly roughened such that incident light is substantially reflected and partially scattered in the absence of condensate.

6. The apparatus according to claim 4, wherein the measurement surface is at least partially formed as a shallow depression.

7. The apparatus according to claim 6, wherein the depression is V-shaped in cross-section.

8. The apparatus according to claim 6, wherein the depression extends as a gully.

9. The apparatus according to claim 6, wherein the depression is inverse-conical in shape.

10. The apparatus according to claim 6, wherein the depression subtends an angle of between approximately 4 and 8 degrees.

11. The apparatus according to claim 6, wherein the depression has a maximum depth of between approximately 0.3 and 0.4 mm.

12. The apparatus according to claim 6, wherein the light source and the light detector are respectively disposed on opposite sides of a plane centered on the depression.

13. The apparatus according to claim 6, wherein the light source and the light detector have respective optical axes each of which subtend an angle of between approximately 10 to 15 degrees from the plane centered on the depression (11b).

14. The apparatus according to claim 4, wherein the light source and the light detector have equivalent focal lengths.

15. The apparatus according to claim 4, wherein the presence of condensate on the measurement surface is determined by the processor according to a predetermined change in the intensity of light detected by the light detector.

16. The apparatus according to claim 1, further comprising:
a detector configured to detect the presence of condensate formed on the measurement surface; and
a controller coupled to the detector and to the cooling device, and configured to control a rate of cooling of the measurement surface according to a signal output by the detector.

17. The apparatus according to claim 16, wherein the rate of cooling is controlled according to a predetermined profile.

18. The apparatus according to claim 16, further comprising a temperature sensor for detecting the temperature of the measurement surface.

19. The apparatus according to claim 18, wherein the controller is coupled to the temperature sensor and controls the rate of cooling of the measurement surface such that the rate of cooling is decreased as the temperature of the measurement surface, as detected by the temperature sensor, nears a predetermined temperature range at which earliest fractions of the gas sample will begin to condense thereon.

20. The apparatus according to claim 19, wherein a cooling rate of between approximately 0.01 and 0.5 degrees Celsius/second is effected near the condensation temperature.

21. An apparatus for measuring a condensation property of a condensable component of a gas sample, comprising:
a measurement surface configured to be exposed to the gas sample and upon which at least some of the gas sample condenses for measurement; and
a heating device configured to heat the measurement surface to promote evaporation of the condensate from the measurement surface, to thereby perform a cleaning operation of the measurement surface.

22. The apparatus according to claim 21, further comprising a controller coupled to the heating device and adapted to control a rate of heating of the measurement surface.

23. The apparatus according to claim 22, wherein the controller is configured to control the heating rate of the measurement surface to cause all condensate formed on the measurement surface to evaporate therefrom.

24. The apparatus according to claim 21, wherein the heating device is a Peltier effect device.

25. An apparatus for measuring a condensation property of a condensable component of a pressurized gas sample, comprising:
a measurement cell including a housing and a measurement member which define, at least in part, a pressurizable gas chamber configured to contain the pressurized gas sample, the measurement member having a surface configured to be exposed to the gas sample;
a cooling device configured to cool the measurement member to cause at least some of the gas sample to condense on the measurement surface thereof for measurement, the cooling device being in contact with the measurement member; and
a rigid mounting plate upon which the cooling device and the measurement cell are mounted,
wherein the cooling device is directly mounted on the mounting plate, and the housing of the measurement cell is indirectly mounted on the mounting plate via a resilient member so as to be resiliently displaceable with respect to the mounting plate such that pressure forces generated in the gas chamber are substantially isolated from the cooling device, while substantially uniform thermal contact between the measurement member and the cooling device is maintained.

26. The apparatus according to claim 25, wherein the resilient member comprises Nylon, Acetal, or PTFE.

27. The apparatus according to claim 25, wherein the resilient member is fixed to the mounting plate and has a flange which captures the housing of the measurement cell, the flange being elastically deformable to allow displacement of the housing relative to the mounting plate.

28. An apparatus for measuring a condensation property of a condensable component of a gas sample, comprising:
a measurement surface configured to be exposed to the gas sample;
a detector configured to detect the presence of condensate formed on the measurement surface from the gas sample;
an analyzer coupled to the detector and configured to analyze the presence of condensate formed on the measurement surface according to a signal output by the detector; and
a flameproof enclosure, wherein the measurement surface, the detector, and the analyzer are all contained within the flameproof enclosure.

29. The apparatus according to claim 28, wherein the flameproof enclosure includes a gas inlet, a gas outlet, and a gas flow path between the gas inlet and the gas outlet along which the gas sample travels, the measurement surface being disposed on the gas flow path.

30. The apparatus according to claim 29, wherein the gas inlet and gas outlet include flame arrestors.

31. The apparatus according to claim 30, wherein the flame arrestors comprise metal mesh or sinter material in order to suitably disperse and extinguish a flame path.

32. An apparatus for measuring a condensation property of a condensable component of a gas sample, comprising:
an enclosure including a gas inlet and a gas outlet;
a gas flow path for transit of the gas sample between the gas inlet and the gas outlet;
a measurement surface disposed on the gas flow path and configured to be exposed to the gas sample such that at least some of the gas sample condenses for measurement;
a gas flow valve disposed on the gas flow path for selectively allowing or obstructing passage of gas along the gas flow path; and
a controller configured to electrically control the gas flow valve to obstruct passage of gas along the gas flow path in a power-off condition, the gas flow value having a manual mechanical override to allow passage of gas along the gas flow path in the power-off condition to permit performing a gas purge operation of the gas flow path in the power-off condition.

33. The apparatus according to claim 32, wherein the gas flow valve is a solenoid valve.

34. The apparatus according to claim 33, wherein the manual mechanical override includes a threaded member, rotation of which forces open the closed solenoid valve.

35. An apparatus for measuring a condensation property of condensable components of a gas stream, comprising:
an enclosure having first and second gas inlets and first and second gas outlets;
a first gas flow path for transit of a first gas sample between the first gas inlet and the first gas outlet;
a second gas flow path for transit of a second gas sample between the second gas inlet and the second gas outlet;
a hydrocarbon dew point analyzer including a measurement surface configured to be exposed to the first gas flow path and upon which at least some of the first gas sample condenses for measurement; and
a water dew point analyzer including a measurement surface exposed to the second gas flow path and upon which at least some of the second gas sample condenses for measurement.

36. An apparatus for measuring a condensation property of a condensable component of a pressurized gas sample, comprising:
a measurement cell including a housing and a measurement member which define, at least in part, a pressurizable gas chamber configured to contain the pressurized gas sample, the measurement member including a surface configured to be exposed to the pressurized gas sample for measurement; and
a mounting plate upon which the measurement cell is mounted,
wherein a space lies between the measurement member and the mounting plate and a conduit connects the space to the outside of the measurement cell such that, in response to an over-pressure generated in the gas chamber, the measurement cell is configured to fail in order to allow the over-pressurized gas of the gas chamber to exhaust into the space and to the outside of the measurement cell via the conduit.

37. An apparatus for measuring a condensation property of a condensable component of a gas sample, comprising:
a measurement surface configured to be exposed to the gas sample and upon which at least some of a gas sample condenses for measurement;
a flameproof enclosure within which the measurement surface is disposed; and
apparatus controls configured to be user-operable via a touch screen from outside the enclosure.

38. An apparatus for measuring a condensation property of condensable components of a gas stream, having an interface for connection to a remote monitoring and control device via a network.

39. The apparatus according to claim 38, wherein the network is the internet or a local area network.

40. A system comprising a plurality of apparatus according to claim 38 connected via the network.

41. A method for measuring a condensation property of a condensable component of a gas stream, the method comprising:
exposing a measurement surface to a gas sample;
promoting condensation of at least some of the gas sample on the measurement surface by cooling in a first cooling cycle;
determining the presence of condensate on the measurement surface;
promoting evaporation of condensation from the measurement surface; and
promoting condensation of at least some of the gas sample on the measurement surface by cooling in a second cooling cycle,
wherein, during the second cooling cycle, the rate of cooling is decreased near a temperature at which the presence of condensate was determined in the first cooling cycle such that a condensation temperature of the gas sample is accurately determinable.

42. The method according to claim 41, further comprising:
determining the condensation temperature of the gas sample during the second cooling cycle.

43. The method according to claim 41, further comprising:
providing a light source and transmitting light towards the measurement surface which has been slightly roughened such that incident light is substantially reflected and partially scattered when in the absence of condensate;
positioning a light detector in the path of substantially only the scattered light returned from the measurement surface when in the absence of condensate, and in the path of the light directly reflected from the measurement surface when in the presence of condensate; and
determining the presence of condensate on the measurement surface as a function of a reduction in the intensity of scattered light returned from the measurement surface according to a signal output by the light detector.

44. The method according to claim 43, wherein the light detector and light source are respectively provided on opposing sides of a plane centered on a shallow depression provided on the measurement surface, the light detector and light source having equivalent focal lengths.

45. The method according to claim 44, wherein the depression has an inverse-conical shape subtending an angle of approximately 4 to 8 degrees and a maximum depth of approximately 0.3 to 0.4 mm.

46. The method according to claim 41, further comprising:
providing a chamber in which the measurement surface is disposed; and
pressurizing the chamber with the gas sample for measurement.

47. The method according to claim 41, wherein promoting condensation comprises cooling the measurement surface.

48. The method according to claim 41, wherein promoting condensation comprises initiating a learning sequence to determine an optimum cooling rate profile for the gas sample.

49. The method according to claim 48, wherein the learning sequence is reinitiated according to a change in the parameters of the gas sample.

50. The method according to claim 41, further comprising:
heating the measurement surface to cause condensate to evaporate therefrom.

51. The method according to claim 50, wherein the rate of heating is variably controlled.

52. The method according to claim 50, further comprising:
self-cleaning by heating the measurement surface to cause all condensate to evaporate therefrom.

53. The method according to claim 41, further comprising:
providing the gas sample as a gas stream.

54. The method according to claim 53, wherein the gas sample is measured under continuous gas stream flow conditions.

55. The method according to claim 53, further comprising:
interrupting the gas stream; and
measuring the gas sample under static conditions.
